(19) United States
(12) Patent Application Publication
(10) Pub. No.: US 2022/0304334 A1
(43) Pub. Date: Sep. 29, 2022

(54) FELINE AND CANINE HYDRATION FLUID

(71) Applicant: Shemeta Carson, Stone Mountain, GA (US)

(72) Inventor: Shemeta Carson, Stone Mountain, GA (US)

(21) Appl. No.: 17/210,599

(22) Filed: Mar. 24, 2021

(51) Int. Cl. A23K 10/30; A23K 10/16; A23K 10/22

(52) U.S. Cl. CPC A23K 10/30; A23K 10/16; A23K 10/22; A23K 50/40

(57) ABSTRACT

A feline and canine hydration fluid which includes water, coconut water, chicken liver fluid, fish oil, carrot juice, powdered kelp and brewers dried yeast.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to hydrating formulation and more particularly pertains to a new hydrating formulation for quickly rehydrating a pet who has lost fluids, minerals and amino acids.

### (2) Description of Related Art Including Information Disclosed Under 37 CFR 1.97 and 1.98

The prior art relates to general hydrating formulations used to rehydrate and replace lost minerals.

### BRIEF SUMMARY OF THE INVENTION

An embodiment of the disclosure meets the needs presented above by generally comprising a hydration fluid which includes water, coconut water, chicken liver fluid, fish oil, carrot juice, powdered kelp and brewers dried yeast.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

Not Applicable

### DETAILED DESCRIPTION OF THE INVENTION

A new hydrating formulation embodying the principles and concepts of an embodiment of the disclosure will be described.

The feline and canine hydration fluid generally comprises a combination of fluids and additives which may be given to a pet, such as a canine or feline for the purpose of hydration. The hydration fluid is provided to a pet such that the pet drinks the fluid to replace water, amino acids and minerals.

Generally, the hydration fluid includes ingredients which are commonly found and include:
water, which may comprise distilled water;
coconut water and in particular coconut water which is free of any sweeteners;
chicken liver liquid which is widely available from multiple suppliers;
fish oil;
carrot juice;
powdered kelp; and
brewers dried yeast.

In some embodiments, the hydration fluid includes:
225.0 ml to 250 ml of the water;
125.0 ml to 155 ml of the coconut water;
250 ml to 35.0 ml of the chicken liver fluid;
5.0 ml to 10.0 ml of the fish oil;
25.0 ml to 35.0 ml of the carrot juice;
10.0 grams to 20.0 grams of the powdered kelp; and
10.0 grams to 20.0 grams of the brewers dried yeast.

In one specific embodiment, the hydration fluid includes:
140.0 ml of coconut water;
29.0 ml of chicken liver liquid;
7.0 ml of fish oil;
29.0 ml of carrot juice;
14.0 grams of powdered kelp; and
14.0 grams of brewers dried yeast.

A method of making the hydration fluid includes the following steps:
1) mixing together to form a first component:
   water;
   coconut water;
   chicken liver fluid;
   fish oil;
   powdered kelp; and
   brewers dried yeast;
2) heating the first component such that the first component is brought to a boil, wherein the first component is boiled typically more than at least 1.0 minutes and no more than 7.0 minutes;
3) letting the first component cool to ambient temperature, wherein the first component may be allowed to sit at for between 1.0 hours and 4.0 hours; and
4) adding carrot juice to the first component to define a final formulation, wherein the carrot juice is mixed with the first component with a high amount of agitation such as by shaking or blending for at least 5.0 seconds.

In use, the hydration fluid is poured into a pet drinking vessel in place or as a supplement to water. The hydration fluid will replace lost water, minerals, and amino acids to quickly rehydrate a pet.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A pet hydration fluid mixture including:
water;
coconut water;
chicken liver fluid;
fish oil;
carrot juice;
powdered kelp; and
brewers dried yeast.

2. The pet hydration fluid mixture according to claim 1, wherein:
the water including 225.0 ml to 250 ml of the water;
the coconut water includes 125.0 ml to 155 ml of the coconut water;
the chicken liver fluid includes 250 ml to 35.0 ml of the chicken liver fluid;
the fish oil includes 5.0 ml to 10.0 ml of the fish oil;
the carrot juice includes 25.0 ml to 35.0 ml of the carrot juice;
the powdered kelp includes 10.0 grams to 20.0 grams of the powdered kelp; and
the brewers dried yeast includes 10.0 grams to 20.0 grams of the brewers dried yeast.

3. A method of making a pet hydration fluid comprising the steps of:
mixing together to form a first component:
water;
coconut water;
chicken liver fluid;
fish oil;
powdered kelp; and
brewers dried yeast;
heating the first component such that the first component is brought to a boil;
letting the first component cool to ambient temperature; and
adding carrot juice to the first component to define a final formulation.

4. The method according to claim 3, wherein the first component includes mixing together:
225.0 ml to 250 ml of water;
125.0 ml to 155 ml of coconut water;
250 ml to 35.0 ml chicken liver fluid;
5.0 ml to 10.0 ml of fish oil;
10.0 grams to 20.0 grams of powdered kelp; and
10.0 grams to 20.0 grams of brewers dried yeast.

5. The method according to claim 4, wherein the step of adding carrot juice to the first component comprises 25.0 ml to 35.0 ml of carrot juice.
